(19) United States
(12) Patent Application Publication
(10) Pub. No.: US 2008/0081532 A1
(43) Pub. Date: Apr. 3, 2008

(54) METHOD OF MANUFACTURING DISPLAY DEVICE

(75) Inventor: Hiroyuki OKUNO, Kobe-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 11/782,888

(22) Filed: Jul. 25, 2007

(30) Foreign Application Priority Data
Sep. 28, 2006 (JP) 2006-264789

(51) Int. Cl. H01J 9/00

(52) U.S. Cl. 445/24

(57) ABSTRACT

A display device manufacturing method of manufacturing a display device including a direct-contact structure formed on a glass substrate by directly superposing an Al alloy film forming wiring lines of an Al alloy and a transparent conducting film forming pixel electrodes in direct contact, and a deposit of part or all of an alloying element of the Al alloy or a concentrated layer containing part or all of the alloying element of the Al alloy, sandwiched between the Al alloy film and the transparent conducting film includes a developing process using a resist developer containing an organic base in a concentration between 2 and 3.5% by mass and a sugar alcohol having a carbon number between 4 and 6 in a sugar alcohol concentration between 2 and 10% by mass and not containing any other polyhydric alcohols for developing a resist film in a wiring pattern.

### BACKGROUND OF THE INVENTION

1. Field of the Invention

The present invention relates to a method of manufacturing a display device provided with aluminum alloy (Al alloy) wiring lines formed by processing an Al alloy film, and pixel electrodes formed by processing a transparent conducting film. The Al alloy wiring lines are joined directly to the pixel electrodes to form joints having a low resistivity. The method is capable of efficiently developing a resist film in a pattern exactly coinciding with a design wiring pattern by processing the resist film by a developing process using a special developer, of suppressing the undesirable corrosion of the Al alloy film to the least possible extent, and of efficiently forming accurate wiring pattern.

2. Description of the Related Art

An active matrix type liquid crystal display, which is an example of a display device, has a thin-film transistor (TFT) array substrate provided with thin-film transistors (TFTs) as switching devices, pixel electrodes formed by processing a transparent conducting film, scanning lines and signal lines. The transparent conducting film forming the pixel electrodes is, for example, an indium tin oxide film (ITO film) of indium oxide containing about 10% by mass tin oxide.

The wiring lines connected to the transparent conducting film are made of pure Al or an Al alloy, such as an aluminum-neodymium (Al—Nd) alloy. A barrier metal layer, such as a refractory metal layer of Mo, Cr, Ti or W, is interposed between the Al alloy film or the like and the transparent conducting film to avoid direct contact between the Al alloy film or the like and the transparent conducting film.

The barrier metal layer is interposed between the Al alloy film and the transparent conducting film because direct contact between the Al alloy film and the transparent conducting film increases contact resistance and deteriorate the display quality of the pixels. Such a problem arises because aluminum (Al) is very easily oxidized and the surface of the Al alloy film is easily oxidized in the atmosphere, the Al alloy film is oxidized by oxygen used for and oxygen generated during the formation of a metal oxide film for the pixel electrodes and an aluminum oxide layer is formed in the surface of the Al alloy film. When an insulating layer is formed between the film forming the wiring lines and the pixel electrodes, the contact resistance of contacts between the signal lines and the pixel electrodes increases and hence the image quality of images displayed on a screen deteriorates.

The barrier metal layer is intended to prevent the oxidation of the surface of the Al alloy film and to improve contact between the Al alloy film and the pixel electrodes. A barrier metal layer forming process is indispensable to forming the barrier metal layer between the wiring lines and the pixel electrodes. Therefore, a film forming chamber for forming the barrier metal layer is necessary, and hence the formation of the barrier meal layer increases the cost and reduces productivity.

The applicants of the present patent application previously developed a technique capable of omitting the barrier metal layer, i.e., a technique capable of directly connecting an Al alloy film forming wiring lines and transparent conducting film forming pixel electrodes in direct contact with each other, proposed the technique in JP-A 2004-214106 (Patent document 1), and are making studies to improve the technique.

The technique disclosed in Patent document 1 uses Ag, Ni, Cu or Zn selectively as an alloying element of an Al alloy forming a conducting Al alloy film for forming wiring lines, specifies the alloying element content of the Al alloy, forms a conducting deposit or concentrated layer containing those allying elements between a metal oxide film, such as an ITO film, forming pixel electrodes, and the conducting Al alloy film in direct contact to reduce contact resistance.

A technique for processing an Al alloy film to form wiring lines uses a lithographic method. The lithographic method includes the steps of forming a resist film by applying a resist sensitive to active radiation, such as ultraviolet radiation, far ultraviolet radiation, excimer laser light, x-rays or electron rays, on the Al alloy film, drying the resist film, and selectively irradiating the resist film with the active radiation to form a resist pattern.

An alkali solution used as a developer by a developing process included in the lithographic method does not have adverse effect on the electrical characteristics of semi-conductor devices and liquid crystal display devices. Therefore, the lithographic method uses an alkali developer not containing metal ions. A representative alkali developer is an aqueous solution containing an organic base, such as tetramethylammonium hydroxide (TMAH), as a principal component.

When the lithographic method uses this developer in the developing process for forming a resist pattern on an Al alloy film, the developer is liable to corrode the Al alloy film, and steps are formed due to corrosion in a wiring pattern when the wiring pattern is reworked. An alkali developer capable of suppressing the corrosion of the Al alloy film has been developed in recent years. It is mentioned in JP-A 2003-330204 (Patent document 2) that a mixed aqueous solution prepared by mixing an organic base as a principal component, sugar and a polyhydric alcohol is excellent in corrosion prevention and satisfactory in developing performance.

Known developers including the developer mentioned in Patent document 2 have been developed on an assumption that an Al alloy film is coated with a refractory metal layer of a refractory metal having a high melting point, such as Mo, Cr or Ti, as a barrier metal layer. Therefore, those developers may be excellent in corrosion prevention with an Al alloy film coated with a barrier metal layer, but are not necessarily effective in corrosion prevention with an Al alloy film for direct contact mentioned in Patent document 1.

Aluminum is corroded by an alkali developer more easily than refractory metals having high melting points, such as Mo and Co. Even if developers can exhibit excellent corrosion prevention with an Al alloy film coated with a barrier metal layer of a refractory metal, those developers cannot necessarily exhibit excellent corrosion prevention with a bear Al alloy film.

For example, an Al alloy containing Ni or such is a representative Al alloy capable of being joined to the transparent electrode film in direct contact. An aluminum-nickel (Al—Ni) alloy, as compared with Al—Nd alloys and pure Al, which are widely used for forming liquid crystal display devices, is easily corroded by an alkali developer. It is inferred that the corrosion resistance of the Al—Ni alloy is unsatisfactory and electrochemical reaction between Al and the alloying element, such as Ni promotes electrochemical corrosion of the Al—Ni alloy.

Thus a specially developed developer is needed for forming a wiring pattern when manufacturing a display device provided with an Al alloy film for forming wiring lines and a transparent conducting film which are superposed in direct contact.

### SUMMARY OF THE INVENTION

The present invention has been made in view of those problems and it is therefore an object of the present invention to develop a resist film developing developer to be used for patterning an Al alloy film to manufacture a display device of direct contact construction previously proposed by the applicants of the present patent application by directly superposing an Al alloy film for forming wiring lines and pixel electrodes in direct contact without using a barrier layer of a refractory metal, such as Mo or Cr, having a corrosion suppressing effect on the Al alloy film and capable of developing a resist film in an accurate pattern exactly coinciding with a design pattern, and to provide a technique capable of efficiently manufacturing an accurate display device having an excellent conducting characteristic.

In one aspect, a display device manufacturing method according to the present invention for manufacturing a display device including a direct-contact structure formed by directly superposing an Al alloy film forming wiring lines and a transparent conducting film forming pixel electrodes in direct contact, and a deposit of part or all the alloying element of the Al alloy or a concentrated layer containing part or all the alloying element of the Al alloy, sandwiched between the Al alloy film and the transparent conducting film, includes a developing process using a resist developer containing an organic base in a concentration between 2 and 3.5% by mass and a sugar alcohol having a carbon number between 4 and 6 in a sugar alcohol concentration between 2 and 10% by mass and not containing any other polyhydric alcohols for developing a resist film in a wiring pattern.

Tetramethylammonium hydroxide (TMAH) is a particularly preferable organic base for the resist developer. Sorbitol, mannitol, xylose, xylitol, arabitol and erythritol are preferable sugar alcohols for the resist developer. Those sugar alcohols may be individually used or some of those sugar alcohols may be used in combination.

According to the aspect of the present invention, the display device manufacturing method of manufacturing a display device including a direct-contact structure formed by directly superposing an Al alloy film forming wiring lines and a transparent conducting film forming pixel electrodes in direct contact uses the resist developer containing an organic base and a sugar alcohol respectively in predetermined concentrations for developing a resist film in a wiring pattern. The wiring pattern can be efficiently formed in high accuracy. Even though the Al alloy film forming the wiring lines and the transparent conducting film forming the pixel electrodes are directly superposed in direct contact without forming any barrier metal layer of a refractory metal, such as Mo or Cr, the corrosion of the Al alloy film can be suppressed to the least possible extent. Thus the present invention can complement the technique for manufacturing the display device including a direct-contact structure disclosed in Patent document 1 by the accuracy and efficiency of resolution of the wiring pattern, and can promote the practical application of the technique for manufacturing a display device utilizing the advantage of the direct-contact structure.

### DESCRIPTION OF THE PREFERRED EMBODIMENTS

According to the present invention, a display device manufacturing method of manufacturing a display device including a direct-contact structure formed by directly superposing an Al alloy film and a transparent conducting film uses a specific alkali developer excellent in preventing the corrosion of the Al alloy film and capable of developing a resist film in a resist pattern of high resolution. Thus the display device manufacturing method can manufacture a high-quality display device including wiring lines excellent in conducting characteristic and having a satisfactorily accurate shape.

A display device having a direct-contact structure to which the present invention is applied has, as mentioned in Patent document 1, wiring lines formed by processing an Al alloy film of an Al ally containing at least one of alloying elements including Au, Ag, Zn, Cu, Ni, Sr, Sm, Ge and Bi in a content between about 0.1 and about 6 at % and forms a concentrated layer of the alloying elements between the Al alloy film forming wiring lines and the transparent conducting film forming pixel electrodes or forms a conducting deposit preferably containing greater than thirteen grains of a second phase having major axes not smaller than 0.01 μm in 10000 μm² and preferably in an area ratio above 0.5%. Thus the contact resistance of the contact interface of the direct-contact structure can be reduced to the least possible extent.

Patent document 1 shows that conducting connection can be achieved and the occurrence of the hillock resulting from the insufficient heat resistance of the Al alloy film can be prevented by adding at least one of alloying elements including Nd, Y, Fe and Co in a content between 0.1 and 6 at % to the Al alloy in addition to the foregoing alloying element.

Patent document 1 shows that a direct contact structure including, in the contact interface between an Al alloy film containing at least Ni as an alloying element and having a main phase of aluminum and a transparent conducting film forming pixel electrodes, a second phase of a conducting deposit containing greater than twenty-one grains having major axes not smaller than 0.05 μm in 100 μm², a direct contact structure including, in the contact interface between an Al alloy film containing at least Ni and Nd as alloying elements and having a main phase of aluminum and a transparent conducting film forming pixel electrodes, a second phase of a conducting deposit containing greater than thirty-three grains having major axes not smaller than 0.02 μm in 100 μm², and a direct contact structure including, in the contact interface between an Al alloy film containing at least Ni and Y as alloying elements and having a main phase of aluminum and a transparent conducting film forming pixel electrodes, a second phase of a conducting deposit containing greater than fifty-eight grains having major axes not smaller than 0.01 μm in 100 μ² are satisfactory direct-contact structures not including any metal barrier layer and having a sufficiently low contact resistance.

Patent document 1 shows that an Al alloy film containing Ni and having, as a surface layer, a Ni-concentrated layer of a thickness between 1 and 10 nm having a Ni content equal to the sum of the Ni content of an inner part of the Al alloy film and 8 at % or below has a low contact resistance and can form a direct-contact structure.

The present invention utilizes the technique disclosed in Patent document 1, and uses an aqueous solution containing an organic base in a predetermined concentration and a sugar alcohol having a carbon number between 4 and 6 in a predetermined sugar alcohol concentration as an alkali developer for developing a resist film formed on a direct-contact structure formed by directly superposing an Al alloy film forming wiring lines and a transparent conducting film forming pixel electrodes and not including any metal barrier layer of Mo or Co in a contact interface in a wiring pattern.

Possible organic bases are, for example, amines having substituent groups containing linear, branched or cyclic, primary, secondary or tertiary amine (more concretely, a diaminoalkane, such as 1,3-diaminopropane, an arylamine, such as 4,4′-diaminodiphenylamine and an alkylamine, such as diaminodialkylamine), and heterocyclic bases having a ring skeleton having three to five carbon atoms and one or two heteroatoms of nitrogen, oxygen or sulfur (more concretely, pyrrol, pyrrolidone, pyrrolidone, pyridine, morpholine, pyrazine, piperdine, oxazole and thiazole).

The organic base may be a lower alcohol quaternary ammonium base. Possible lower alcohol quaternary ammonium bases are, for example, tetramethylammonium hydroxide, tetraethylammonium hydroxide, tetrapropylammonium hydroxide, trimethyl (2-hydroxyethyl) ammonium hydroxide, triethyl-(2-hydroxyethyl) ammonium hydroxide, tripropyl (2-hyroxy-ethyl) ammonium hydroxide, and trimethyl (1-hydroxypropyl)-ammonium hydroxide. Tetramethylammonium hydroxide (TMAH) among those organic bases is particularly preferable.

Those organic bases may be individually used or some of those organic bases may be used in combination. The present invention recommends using a mixture organic base containing TMAH as a principal component and one or plurality of those organic bases.

Possible sugar alcohols are those having four to six atoms, such as sorbitol, xylitol, erythritol, mannitol, iditol, xylose, ribitol, arabitol, threitol, voremitol, perseitol, octitol and galactitol. Those sugar alcohols may be individually used or some of those sugar alcohols may be used in combination. From the viewpoint of preventing the Al alloy film from corrosion, sorbitol, mannitol, xylose, xylitol, arabitol and erythritol are particularly preferable sugar alcohols among those sugar alcohols.

An alkali developer to be used by the present invention is an aqueous solution of the foregoing organic base and the foregoing sugar alcohol having an organic base concentration between 2 and 3.5% by mass and a sugar alcohol concentration between 2 and 10% by mass. An alkali developer having an organic base concentration below 2% by mass is incapable of satisfactorily dissolving a resist film and hence the resist film cannot be properly developed in a desired wiring pattern. An alkali developer having an organic base content above 3.5% by mass reduces the thickness of parts of a resist film forming a wiring pattern excessively and reduces the width of parts of the resist film forming the wiring pattern excessively. Consequently, a wiring pattern cannot be formed as it is designed. If the sugar alcohol concentration is below 2% by mass, the corrosion of the Al alloy film forming wiring lines cannot be satisfactorily prevented. If the alkali developer has a sugar alcohol concentration above 10% by mass, the rate of dissolving exposed parts of a resist film to be removed is low, the developing performance of the alkali developer is unsatisfactory and an accurate wiring pattern cannot be formed. Preferably, the alkali developer has a sugar alcohol concentration between 4 and 8% by mass to ensure preventing the Al alloy film from corrosion, to dissolve exposed parts of a resist film at a sufficiently high dissolving rate and to develop the resist film in an accurate wiring pattern.

It is essential that the alkali developer to be used by the present invention contains an organic base and a sugar alcohol having a carbon number between four and six respectively in predetermined concentrations. The alkali developer containing an organic base and a sugar alcohol respectively in the predetermined concentrations may contain additives, such as a lubricant, a moistening agent and/or a surface-active agent, in a concentration that will not adversely affect the corrosion prevention of the Al alloy film and the development of a resist film. As will be apparent from the results of experiments, which will be described later, an alkali developer cannot exercise corrosion prevention and developing performance intended by the present invention when the alkali developer contains a polyhydric alcohol, such as ethylene glycol, propanediol or glycerin, other than a sugar alcohol having a carbon number between four and six. The other component of the alkali developer is water, namely, a solvent, and impurities unavoidably contained in the alkali developer. When necessary, a small amount of a hydrophilic, organic solvent, such as a monohydric alcohol, ketone or an acetate, may be added to the alkali developer.

A resist forming a resist film to be developed by the alkali developer may be of any type, such as a positive type or a negative type, provided that the resist film can be developed by the alkali developer. A possible positive resist is a resist containing a novolak resin. A possible negative resist is a resist containing a cyclized rubber.

A developing method of developing a resist film of such a resist is not a special one; the resist film can be developed by an ordinary developing method or a modified developing method invented by modifying a known developing method. In all cases, the corrosion of the Al alloy film by the developer can be suppressed to the least extent and an accurate wiring pattern can be efficiently and surely formed by forming a resist film by applying a resist sensitive to active radiation, such as ultraviolet radiation, far ultraviolet radiation, excimer laser light, x-rays or electron rays, on an Al alloy film, drying the resist film, and selectively irradiating parts of the resist film with the active radiation to form a latent wiring pattern in the resist film, processing the exposed resist film by a developing process to dissolve and remove parts of the resist film selectively.

### EXAMPLE

The present invention will be described in terms of examples.

Experiments 1 to 13

Test alkali developers respectively having compositions shown in Table 1 for Experiments 1 to 13 were prepared by dissolving TMAH and sugar alcohols shown in Table 1 in water. Resist films were formed on direct-contact structures each formed by directly superposing an Al alloy film and a transparent, conducting film in direct contact. Exposed resist films were subjected to developing processes by using the test alkali developers, respectively, to form a wiring pattern in the resist films on the direct-contact structures, respectively. The corrosion preventing effect of the alkali developers in preventing the corrosion of the Al ally films, and the developing characteristics of the alkali developers in developing the exposed resist films were examined.

The Al ally used for the experiments had an Al content of 2 at % and a Ni content of 0.35 at %. The Al alloy films were formed in a thickness of 300 nm by a dc magnetron sputtering process. Conditions for the dc magnetron sputtering process were an Ar gas atmosphere, a process pressure of 2 mtorr and a sputtering power density of 3.3 W/cm². A sample resist film for evaluating the developing characteristic of each alkali developer was formed by spreading a positive resist containing a novolak resin on a glass substrate in a resist film, baking the resist film at 80° C. for 30 min in an oven, and processing the baked resist film by an exposure process by an exposure system. The corrosion preventing property of each alkali developer was tested by immersing the Al alloy film in the alkali developer for 1 min and 2 min, cleaning the immersed Al alloy film with pure water, and measuring a thickness decrement of the Al alloy film. The corrosion preventing property was evaluated on the basis of the thickness decrement.

Results of evaluation are shown in Table 1. A developer not containing any sugar alcohol was used as a reference developer. The developing property of the test developer was compared with that of the reference developer. The corrosion preventing property of each developer was evaluated by the foregoing corrosion preventing property testing method. The corrosion preventing property of the developer was rated satisfactory when the test Al alloy film was etched at an etch rate not higher than 15 nm/min. The corrosion preventing property of the developer was rated unsatisfactory when the Al alloy film was etched at an etch rate exceeding 15 nm/min. In Table 1, a blank circle and a cross indicate a satisfactory corrosion preventing property and an unsatisfactory corrosion preventing property, respectively.

TABLE 1

| | Organic base | | Sugar alcohol | | Corrosion | |
|---|---|---|---|---|---|---|
| | | Concentration | | Concentration | preventing | Developing |
| Experiment No. | Name | (% by mass) | Name | (% by mass) | property | property |
| 1 | TMAH | 2.3 | Sorbitol | 5 | ∘ | ∘ |
| 2 | TMAH | 3.5 | Sorbitol | 5 | ∘ | ∘ |
| 3 | TMAH | 3.5 | Sorbitol | 2 | ∘ | ∘ |
| 4 | TMAH | 3.5 | Sorbitol | 10 | ∘ | ∘ |
| 5 | TMAH | 5.0 | Sorbitol | 5 | ∘ | x |
| 6 | TMAH | 2.3 | Sorbitol | 1 | x | ∘ |
| 7 | TMAH | 2.3 | Sorbitol | 11 | ∘ | x |
| 8 | TMAH | 3.5 | Xylitol | 5 | ∘ | ∘ |
| 9 | TMAH | 3.5 | Erythritol | 5 | ∘ | ∘ |
| 10 | TMAH | 3.5 | Glycerin | 5 | x | x |
| 11 | TMAH | 3.5 | Ethylene glycol | 5 | x | x |
| 12 | TMAH | 2.3 | — | — | x | ∘ |
| 13 | TMAH | 3.5 | — | — | x | x |

*TMAH: Tetramethylammonium hydroxide

The followings are known from Table 1. The developers used for Experiments Nos. 1 to 4, 8 and 9 were those meeting conditions specified by the present invention and were satisfactory in both corrosion preventing property effective in preventing the corrosion of the Al alloy film and developing property effective in developing the resist film. The developer used for Experiment No. 5 had an excessively high TMAH concentration and reduced the size of parts of the wiring pattern formed in the resist film excessively causing defective development. The developer used for Experiment No. 6 had an excessively low sugar alcohol concentration, could not exercise satisfactory corrosion prevention. The developer used for Experiment No. 7 had an excessively high sugar alcohol concentration and caused defective development. The alcohols contained in the developers used for Experiments Nos. 10 and 11 had an insufficient carbon number and the corrosion preventing properties and developing properties thereof were scarcely improved. The developers used for Experiments Nos. 12 and 13 were in comparative examples containing only an organic base. Developers having a TMAH concentration of 2.3% by mass were not unsatisfactory in developing property, but had a corrosion preventing property not improved at all. Developers having a TMAH concentration of 3.5% by mass were unsatisfactory in both corrosion preventing property and developing property.

Although the present invention has been described in its preferred examples with a certain degree of particularity, obviously many changes and variations are possible therein. It is therefore to be understood that the present invention may be practiced otherwise than as specifically described herein without departing from the scope and spirit thereof.

What is claimed is:

1. A display device manufacturing method of manufacturing a display device comprising a direct-contact structure formed on a glass substrate by directly superposing an Al alloy film forming wiring lines of an Al alloy and a transparent conducting film forming pixel electrodes in direct contact, and a deposit of part or all of an alloying element of the Al alloy or a concentrated layer containing part or all of the alloying element of the Al alloy, sandwiched between the Al alloy film and the transparent conducting film, said display device manufacturing method comprising a developing process using a resist developer containing an organic base in a concentration between 2 and 3.5% by mass and a sugar alcohol having a carbon number between 4 and 6 in a sugar alcohol concentration between 2 and 10% by mass and not containing any other polyhydric alcohols for developing a resist film in a wiring pattern.

2. The display device manufacturing method according to claim 1, wherein the organic base contained in the resist developer is tetramethylammonium hydroxide.

3. The display device manufacturing method according to claim 1, wherein the sugar alcohol contained in the resist developer is sorbitol, mannitol, xylose, xylitol, arabitol or erythritol.

4. The display device manufacturing method according to claim 2, wherein the sugar alcohol contained in the resist developer issorbitol, mannitol, xylose, xylitol, arabitolorerythritol.
